(19) United States
(12) Patent Application Publication
(10) Pub. No.: US 2022/0245452 A1
(43) Pub. Date: Aug. 4, 2022

(54) Distributed Deep Learning System

(71) Applicant: Nippon Telegraph and Telephone Corporation, Tokyo (JP)

(72) Inventors: Yuki Arikawa, Tokyo (JP); Kenji Kawai, Tokyo (JP); Junichi Kato, Tokyo (JP); Huycu Ngo, Tokyo (JP); Tsuyoshi Ito, Tokyo (JP); Kenji Tanaka, Tokyo (JP); Takeshi Sakamoto, Tokyo (JP)

(21) Appl. No.: 17/614,829

(22) PCT Filed: May 31, 2019
(86) PCT No.: PCT/JP2019/021792

§ 371 Date: Nov. 29, 2021

(51) Int. Cl. G06N 3/08; G06N 3/04

(52) U.S. Cl. CPC G06N 3/08; G06N 3/04

(57) ABSTRACT

A computing interconnect apparatus includes a reception unit configured to receive a packet transmitted from each of learning nodes and acquire a value of a gradient stored in the packet, an adder configured to calculate a sum of the gradient acquired by the reception unit in parallel separately for each of processing units in accordance with the number of the processing units to be carried out being determined by bit precision of the gradient and a desired processing speed, and a transmission unit configured to write calculation results of the sum of the gradient separate for each of the processing units being obtained by the adder into packetization and transmit the calculation results to each of the learning nodes.

### CROSS-REFERENCE TO RELATED APPLICATION

This application is a national phase entry of PCT Application No. PCT/JP2019/021792, filed on May 31, 2019, which application is hereby incorporated herein by reference.

### TECHNICAL FIELD

The present invention relates to a distributed deep learning system that executes deep learning, which is machine learning using a neural network, by using a plurality of learning nodes in a distributed and collaborative manner.

### BACKGROUND

Through utilization of machine learning for various pieces of information and data, improvement of services and provision of added values have been actively carried out. It is often the case that great calculation resources are required in such machine learning. In particular, in machine learning using a neural network referred to as deep learning, a great amount of data for learning needs to be processed in learning which is the process of optimizing configuration parameters of the neural network. To achieve a high speed in the learning processing, performing parallel processing in a plurality of arithmetic apparatuses leads to one solution.

For example, NPL 1 discloses a distributed deep learning system in which four learning nodes and an InfiniBand switch are connected via an InfiniBand network. Each learning node is equipped with four graphics processing units (GPUs). The distributed deep learning system disclosed in NPL 1 aims to achieve a high speed by subjecting learning arithmetic to parallel processing by using the four learning nodes.

NPL 2 discloses a configuration in which a learning node(s) (GPU server(s)), each of which is equipped with eight GPUs, and an Ethernet (trade name) switch are connected via an Ethernet network. NPL 2 discloses examples of cases in which 1, 2, 4, 8, 16, 32, and 44 learning nodes are used. In the system disclosed in NPL 2, machine learning is performed by using the distributed synchronous stochastic gradient descent method (stochastic gradient descent (SGD)). Specifically, machine learning is performed according to the following procedure.

(I) Some pieces of learning data are extracted. A set of the extracted pieces of learning data is referred to as a mini-batch. (II) The mini-batch is divided into the same number as the number of GPUs, so as to be assigned to each of the GPUs. (III) In each GPU, a loss function L(w), which serves as an index for indicating how much output values from the neural network obtained when the learning data assigned in (II) is input are deviated from true values (referred to as teaching data) is calculated. In the process of calculating the loss function, the output values are sequentially calculated from the input-side layer toward the output-side layer of the neural network, and the process is hence referred to as forward propagation.

(IV) In each GPU, partial differential values (gradients) of respective configuration parameters (weights of the neural network or the like) of the neural network for the loss function value calculated in (III) are calculated. In the process, the gradients for the configuration parameters of each layer are sequentially calculated from the output-side layer toward the input-side layer of the neural network, and the process is hence referred to as back propagation.

(V) The average of the gradients calculated for each GPU is calculated.

(VI) In each GPU, using the average value of the gradients calculated in (V), the configuration parameters of the neural network are updated using the stochastic gradient descent method (stochastic gradient descent (SGD)) so that the loss function L(w) is diminished more. The stochastic gradient descent method is calculation processing of diminishing the loss function L(w) by changing the values of the configuration parameters only slightly in a direction of the gradients. Through repetition of the processing, the neural network is updated to one having a smaller loss function L(w), specifically, one having higher precision that outputs values closer to the true values.

Further, NPL 3 discloses a distributed deep learning system having a configuration in which 128 learning nodes equipped with eight GPUs are connected via an InfiniBand network.

In each distributed deep learning system of any of NPLs 1 to 3, it is indicated that as the number of learning nodes is increased, the learning speed is increased and a learning time period can be reduced. In this case, because the average value of the neural network configuration parameters such as the gradients calculated in each learning node is calculated, calculation such as average value calculation needs to be performed by transmitting and receiving these configuration parameters among the learning nodes.

On the other hand, as the number of nodes is increased to increase the number of parallel processings, necessary communication processing is rapidly increased. As in the prior art, when arithmetic processing such as average value calculation and transmission and reception processing of data are performed in the learning nodes using software, there is a problem in that overhead related to communication processing is increased, making it difficult to sufficiently increase learning efficiency.

NPL 3 discloses a relationship between a period of time required for performing 100 cycles of learning processing, a period of time required for communication out of the above-mentioned period of time, and the number of GPUs. According to the relationship, as the number of GPUs is increased, a period of time required for communication is increased, which in particular is drastically increased when the number of GPUs is 512 or more.

### CITATION LIST

### Non Patent Literature

NPL 1: Rengan Xu and Nishanth Dandapanthu, “Performance of Deep Learning Using NVIDIA (trade name) Tesla (trade name) P100 GPU”, Dell Inc., 2016, Internet http://ja.community.dell.com/techcenter/m/mediagallery/3765/download
NPL 2: Priya Goyal, Piotr Dollar, Ross Girshick, Pieter Noordhu is, Lukasz Wesolowski, Aapo Kyrola, Andrew Tulloch, Yangqing Jia, Kai ming He, “Accurate, Large Minibatch SGD: Training ImageNet in 1 Hour”, Cornell University Library, the U.S., arXiv:1706.02677, 2017, Internet https://arxiv.org/abs/1706.02677
NPL 3: Takuya Akiba, Shuji Suzuki, Keisuke Fukuda, “Extremely Large Minibatch SGD: Training ResNet-50 on ImageNet in 15 Minutes”, Cornell University Library, the U.S., arXiv:1711.04325, 2017, Internet <https://arxiv.org/abs/1711.04325>

### SUMMARY

### Technical Problem

An object of embodiments of the present invention is to provide a distributed deep learning system capable of performing collaborative processing among learning nodes connected via a communication network at a high speed while achieving a high speed by performing parallel processing for learning by using a large number of learning nodes connected to the communication network.

### Means for Solving the Problem

A distributed deep learning system embodiment according to the present invention includes: a plurality of learning nodes; and a computing interconnect apparatus connected to the plurality of learning nodes via a communication network. Each of the plurality of learning nodes includes a gradient calculation unit configured to calculate a gradient of a loss function, based on output results obtained by inputting learning data to a neural network of a learning target, a first transmission unit configured to write calculation results of the gradient calculation unit into a packet and transmit the calculation results to the computing interconnect apparatus, a first reception unit configured to receive the packet transmitted from the computing interconnect apparatus and acquire a value stored in the packet, and a configuration parameter update unit configured to update a configuration parameter of the neural network, based on the value acquired by the first reception unit. The computing interconnect apparatus includes a second reception unit configured to receive the packet transmitted from each of the plurality of learning nodes and acquire a value of the gradient stored in the packet, an adder configured to calculate a sum of the gradient acquired by the second reception unit in parallel separately for each of processing units in accordance with the number of the processing units to be carried out being determined by bit precision of the gradient and a desired processing speed, and a second transmission unit configured to write calculation results of the sum of the gradient separate for each of the processing units being obtained by the adder into packetization and transmit the calculation results to each of the plurality of learning nodes.

Further, a distributed deep learning system embodiment according to the present invention includes: a plurality of learning nodes; and a plurality of computing interconnect apparatuses connected to the plurality of respective learning nodes via a communication network. The plurality of computing interconnect apparatuses are connected by a ring communication network configured to perform communication only in one direction. Each of the plurality of learning nodes includes a gradient calculation unit configured to calculate a gradient of a loss function, based on output results obtained by inputting learning data to a neural network of a learning target, a first transmission unit configured to write calculation results of the gradient calculation unit and transmit the calculation results to one of the plurality of computing interconnect apparatuses connected to the learning node, a first reception unit configured to receive the packet transmitted from the computing interconnect apparatus connected to the learning node and acquire a value stored in the packet, and a configuration parameter update unit configured to update a configuration parameter of the neural network, based on the value acquired by the first reception unit. A first computing interconnect apparatus out of the plurality of computing interconnect apparatuses includes a second reception unit configured to receive the packet transmitted from one of the plurality of learning nodes connected to the first computing interconnect apparatus and acquire a value of the gradient stored in the packet, a third reception unit configured to receive the packet transmitted from one of the plurality of computing interconnect apparatuses being adjacent on an upstream side and acquire the calculation results of a sum of the gradient stored in the packet, a second transmission unit configured to write the value of the gradient acquired by the second reception unit or the calculation results of the sum of the gradient acquired by the third reception unit into the packet and transmit the value or the calculation results to one of the plurality of computing interconnect apparatuses being adjacent on a downstream side, and a third transmission unit configured to write the calculation results of the sum of the gradient acquired by the third reception unit into the packet and transmit the calculation results to the learning node connected to the first computing interconnect apparatus. A second computing interconnect apparatus other than the first computing interconnect apparatus out of the plurality of computing interconnect apparatuses includes a fourth reception unit configured to receive the packet transmitted from one of the plurality of computing interconnect apparatuses being adjacent on the upstream side and acquire the value stored in the packet, a fifth reception unit configured to receive the packet transmitted from one of the plurality of learning nodes connected to the second computing interconnect apparatus and acquire the value of the gradient stored in the packet, an adder configured to calculate the sum of the gradient or the calculation results of the sum of the gradient acquired by the fourth reception unit and the gradient acquired by the fifth reception unit in parallel separately for each of processing units in accordance with the number of the processing units to be carried out being determined by bit precision of the gradient and a desired processing speed, a fourth transmission unit configured to write the calculation results of the sum of the gradient separate for each of the processing units being obtained by the adder or the calculation results of the sum of the gradient acquired by the fourth reception unit into the packet and transmit the calculation results to one of the plurality of computing interconnect apparatuses being adjacent on the downstream side, and a fifth transmission unit configured to write the calculation results of the sum of the gradient acquired by the fourth reception unit into the packet and transmit the calculation results to one of the plurality of learning nodes connected to the second computing interconnect apparatus.

### Effects of Embodiments of the Invention

According to embodiments of the present invention, transmission and reception processing of communication packets between the computing interconnect apparatus and each learning node can be subjected to hardware processing at high speed simultaneously in parallel with each other. The distributed deep learning can hence be processed at higher speed as compared to a case in which communication processing and addition processing of the gradients are subjected to software processing in a conventional head node. Further, according to embodiments of the present invention, by changing the number of adders to be used for calculation in accordance with the bit precision of the gradients, the sum of the gradients can be calculated at a desired processing speed (processing speed corresponding to the transmission rate of the communication network), regardless of the bit precision of the gradients.

### BRIEF DESCRIPTION OF THE DRAWINGS

FIG. 1 is a block diagram illustrating a configuration of a distributed deep learning system according to a first embodiment of the present invention.

FIG. 2 is a block diagram illustrating a configuration of a two-layer neural network.

FIG. 3 is a diagram illustrating operations of buffer units, extraction units, and an addition unit of a computing interconnect apparatus according to the first embodiment of the present invention.

FIG. 4 is a flowchart illustrating operation of the computing interconnect apparatus according to the first embodiment of the present invention.

FIG. 5 is a block diagram illustrating a configuration of a learning node of the distributed deep learning system according to the first embodiment of the present invention.

FIG. 6 is a block diagram illustrating a configuration of a distributed deep learning system according to a second embodiment of the present invention.

FIG. 7 is a diagram illustrating operations of extraction units, buffer units, and an addition unit of a computing interconnect apparatus according to the second embodiment of the present invention.

FIG. 8 is a flowchart illustrating operation of the computing interconnect apparatus according to the second embodiment of the present invention.

FIG. 9 is a block diagram illustrating a configuration of a distributed deep learning system according to a third embodiment of the present invention.

FIG. 10 is a diagram illustrating operation of the distributed deep learning system according to the third embodiment of the present invention.

FIG. 11 is a block diagram illustrating a configuration of a child computing interconnect apparatus of the distributed deep learning system according to the third embodiment of the present invention.

FIG. 12 is a block diagram illustrating a configuration of a parent computing interconnect apparatus of the distributed deep learning system according to the third embodiment of the present invention.

FIG. 13 is a block diagram illustrating a configuration example of a computer that implements the learning nodes of the distributed deep learning system according to the first to third embodiments of the present invention.

### DESCRIPTION OF EMBODIMENTS

Embodiments of the present invention will be described below with reference to the drawings.

### Configuration of First Embodiment

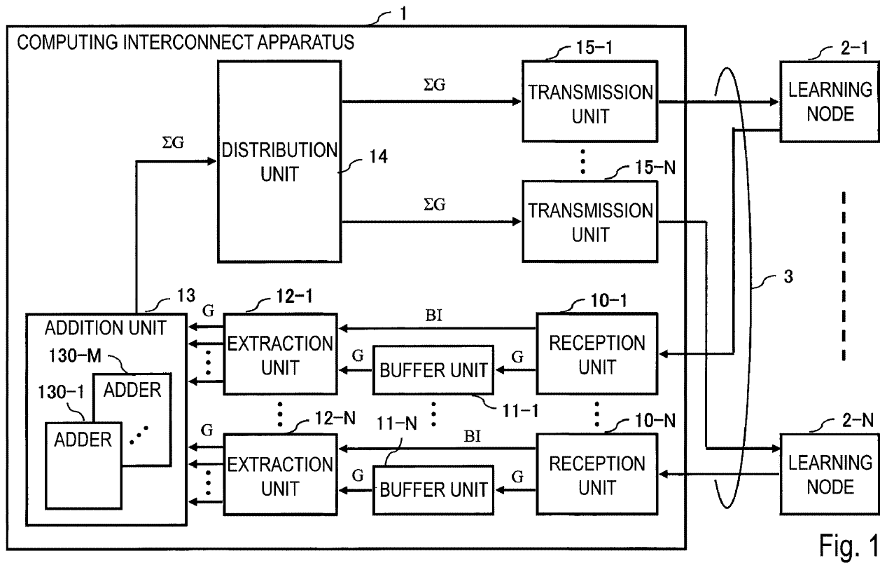

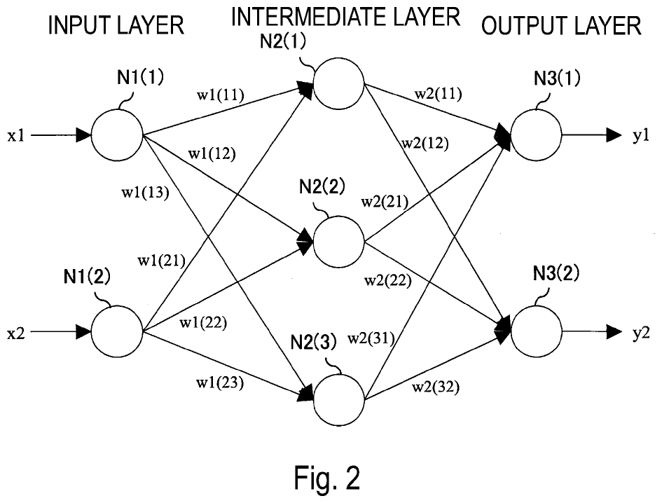

First, with reference to FIGS. 1 to 2, a configuration of a distributed deep learning system according to the first embodiment of the present invention will be described. FIG. 1 is a block diagram illustrating a configuration of a distributed deep learning system according to the first embodiment. The distributed deep learning system includes a computing interconnect (CI) apparatus 1 and N (N is an integer of 2 or greater) learning nodes 2-1 to 2-N.

The learning nodes 2-1 to 2-N are connected to the computing interconnect apparatus 1 via a communication network 3. As the communication network 3, a network for performing communication by exchanging communication packets is used, such as Ethernet and InfiniBand. In the present embodiment, a star network configuration is adopted.

Note that, in embodiments of the present invention, the computing interconnect apparatus or the learning node signifies an apparatus that is deployed in a distributed manner in a network.

### Description of Learning Nodes

Each of the learning nodes 2-1 to 2-N is an apparatus having a learning function of calculating output values of a neural network being a mathematical model constructed as software, and further updating weight values being configuration parameters of the neural network according to learning data so as to enhance precision of the output values. The neural network is constructed in each of the learning nodes 2-1 to 2-N.

As an implementation method of the learning nodes 2-1 to 2-N, the learning nodes 2-1 to 2-N may be implemented on software of a central processing unit (CPU) or a GPU, or the learning nodes 2-1 to 2-N may be implemented by a large scale integration (LSI) circuit that is formed on a field programmable gate array (FPGA) or an application specific integrated circuit (ASIC).

### Description of Learning

Learning processing of the neural network in the learning nodes 2-1 to 2-N will be described by taking learning with teaching data as an example. FIG. 2 illustrates a quite simple two-layer neural network including an input layer (first layer), an intermediate layer (second layer), and an output layer (third layer), as an example of the neural network. Nk(i) of FIG. 2 represents the k-th layer and the i-th neuron. x1 and x2 each represent input, y1 and y2 each represent output, w1(11), w1(12), . . . , w1(23) each represent a weight parameter of the first layer, and w2(11), w2(12), . . . , w2(32) each represent a weight parameter of the second layer.

In a case of the learning with teaching data, corresponding teaching data (true data) is provided in each piece of learning data in advance, and the configuration parameters of the neural network are updated in such a manner that the output values of the neural network become closer to the teaching data. The configuration parameters of the neural network in the case of the example of FIG. 2 are the weights w1(11), w1(12), . . . , w1(23) and w2(11), w2(12), . . . , w2(32). By optimizing these configuration parameters, the precision of the neural network is enhanced.

Specifically, a loss function, which serves as an index for indicating how much the output values of the neural network are deviated from the teaching data, is defined, and the configuration parameters are updated so that the loss function is diminished. In the present example, a loss function L is expressed as in expression (i), for example, where t1 and t2 represent the teaching data corresponding to pieces of the input learning data x1 and x2.

$$L = \frac{1}{2} {\sum }_{k = 1}^{2} {( {y}_{k} - {t}_{k} )}^{2} \qquad ( 1 )$$

Next, partial differential values (referred to as gradients) of respective configuration parameters of the neural network for the loss function L are calculated. In the present example, the gradients are expressed as in expression (2).

$$( \frac{\partial L}{\partial w 1 ( 11 )} , \frac{\partial L}{\partial w 1 ( 12 )} , … , \frac{\partial L}{\partial w 1 ( 23 )} , \frac{\partial L}{\partial w 2 ( 11 )} , \frac{\partial L}{\partial w 2 ( 12 )} , … , \frac{\partial L}{\partial w 2 ( 32 )} ) \qquad ( 2 )$$

Next, using the gradients, the configuration parameters of the neural network are updated so that the loss function L is diminished more. Although there are various methods for updating, each of the weight parameters is updated as shown in expression (3) by using the gradient descent method, for example.

$$w 1 ( 11 ) ← w 1 ( 11 ) - η \frac{\partial L}{\partial w 1 ( 11 )} \\ … \\ w 2 ( 32 ) ← w 2 ( 32 ) - η \frac{\partial L}{\partial w 2 ( 32 )} \qquad ( 3 )$$

Here, η represents a constant referred to as a learning rate. According to expression (3), each of the weight parameters is changed by the amount proportional to the learning rate η in a direction opposite to the gradient, specifically, in a direction of diminishing the loss function L. Accordingly, the loss function L of the neural network after the update is diminished in comparison to the loss function L before the update.

In this manner, processing of calculation of the loss function L, calculation of the gradients, and update of the configuration parameters is performed on a single pair of the pieces of input learning data. Then, subsequent pieces of input learning data are input to the neural network having the updated configuration parameters, and the same processing is performed, so as to update the configuration parameters. Through repetition of the cycle, learning of the neural network is performed by performing update to a neural network having a diminished loss function L.

Here, in the process of calculating the loss function L, the output values are sequentially calculated from the input layer toward the output layer of the neural network, and the process is hence referred to as forward propagation. On the other hand, in the process of calculating the gradients, a method referred to as back propagation is in many cases used, where the gradients for the configuration parameters of each layer are sequentially calculated from the output layer toward the input layer of the neural network.

### Distributed Learning Processing Performed by Plurality of Conventional Learning Nodes

In order to achieve sufficient precision with the learning of the neural network as described above, it is necessary to input a large amount of learning data to the neural network and repeat the learning processing, which requires a long period of time. Reducing the period of time required for the learning brings a great advantage.

To reduce the period of time required for the learning, a method of distributed collaborative learning is employed, where a total learning time period is reduced by providing a plurality of learning nodes of the same neural network and causing the learning data to be learned in parallel separately in the learning nodes. The procedure of conventional distributed learning processing will be described.

First, learning data is divided into the same number as the number of learning nodes, so as to be assigned to each of the learning nodes. The learning nodes input their respective pieces of learning data to the neural network, and calculate their respective loss functions L by using the method of forward propagation. A single loss function L is obtained for each learning (each neural network). Subsequently, the learning nodes calculate gradients of the loss function L by using the method of back propagation. The gradients of the loss function L are each a vector including a component of each configuration parameter as shown in expression (2). In embodiments of the present invention, such a gradient vector is simply referred to as a gradient.

Next, the gradients calculated in respective learning nodes are sent to a head node, for example, the average of the gradients is calculated in the head node, and the calculated results are returned from the head node to each of the learning nodes. Note that the sum of the gradients may be calculated instead of the average of the gradients. In this case, for example, multiplication of the learning rate η at the time of update processing of a subsequent weight parameter by (i/number of learning nodes) leads to the same result as in the case of obtaining the average value of the gradients. Finally, each learning node updates the weight parameters of the neural network by using the average value of the gradients. Through the above procedure, one cycle of conventional distributed learning ends.

### Distributed Processing According to Present Embodiment

Next, distributed learning processing according to the present embodiment will be described. The computing interconnect apparatus 1 according to the present embodiment includes a plurality of reception units 10-1 to 10-N (second reception units), a plurality of buffer units 11-1 to 11-N, a plurality of extraction units 12-1 to 12-N, an addition unit 13, a distribution unit 14, and a plurality of transmission units 15-1 to 15-N (second transmission units). The plurality of reception units 10-1 to 10-N (second reception units) are respectively provided for the learning nodes 2-1 to 2-N, and acquire calculation results of the gradients from communication packets transmitted from the learning nodes 2-1 to 2-N. The plurality of buffer units 11-1 to 11-N are respectively provided for the learning nodes 2-1 to 2-N, and store values of the gradients acquired by the reception units 10-1 to 10-N for their respective learning nodes. The plurality of extraction units 12-1 to 12-N are respectively provided for the learning nodes 2-1 to 2-N, and output the values of the gradient respectively read from the buffer units 11-1 to 11-N for the respective learning nodes to the adder 130 at the subsequent stage separately for each processing unit. The addition unit 13 includes a plurality of adders 130 that calculate the sum of the gradients output from the extraction units 12-1 to 12-N in parallel separately for each processing unit in accordance with the number of processing units to be carried out, which is determined by bit precision of the gradients and a desired processing speed. The distribution unit 14 outputs calculation results of the sum of the gradients calculated by the addition unit 13 to the transmission units 15-1 to 15-N at the subsequent stage. The plurality of transmission units 15-1 to 15-N (second transmission units) are respectively provided for the learning nodes 2-1 to 2-N, and write the calculation results of the sum of the gradients output from the distribution unit 14 into the communication packets and transmit the calculation results to the corresponding learning nodes 2-1 to 2-N.

The reception units 10-1 to 10-N extract values of gradients G from received communication packets and output the gradients G to the buffer units 11-1 to 11-N, and also output bit precision information BI of the gradients G to the extraction units 12-1 to 12-N, respectively. The bit precision information BI refers to information indicating bit precision, such as double precision, single precision, and half-precision, for example. If the bit precision supported by the distributed deep learning system according to embodiments of the present invention is determined in advance, each of the learning nodes 2-1 to 2-N can report the bit precision of the gradients G by setting a flag at a predetermined position of the communication packets.

Note that a reporting method regarding the bit precision is not limited to the above method. For example, by selecting an operation mode of the computing interconnect apparatus 1 corresponding to the bit precision of the gradients G before starting learning, the effect the same as the output of the bit precision information BI can be obtained. In this case, the reporting from the reception units 10-1 to 10-N to the extraction units 12-1 to 12-N is unnecessary.

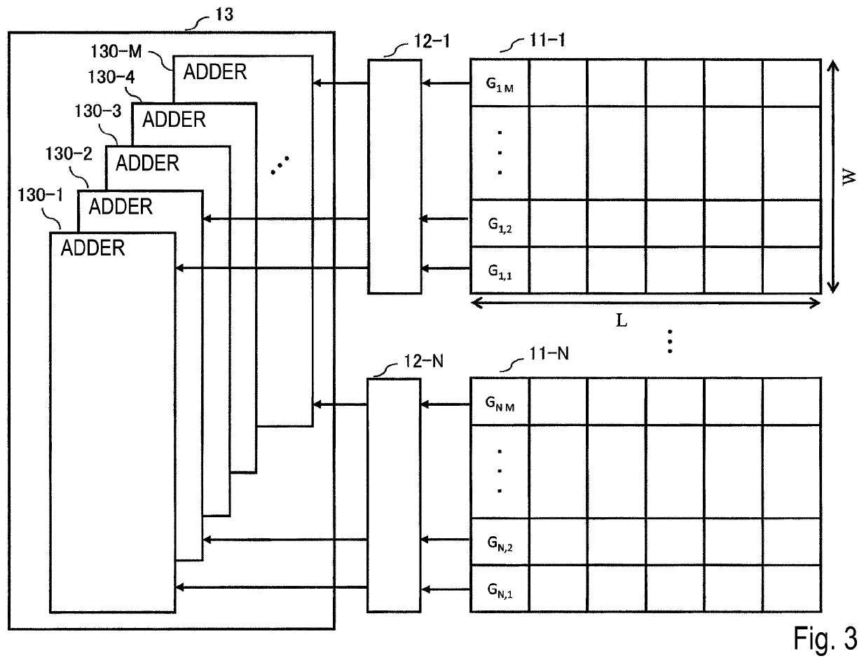

FIG. 3 is a diagram illustrating operations of the buffer units 11-1 to 11-N, the extraction units 12-1 to 12-N, and the addition unit 13 of the computing interconnect apparatus 1 according to the present embodiment. As illustrated FIG. 3, each of the buffer units 11-1 to 11-N includes a buffer memory having a data width W and a buffer length L. Each of the buffer units 11-1 to 11-N can store pieces of data of the gradients G, with an area of the data width W (an area of one column of each of the buffer units 11-1 to 11-N of FIG. 3) being used as an area for one word. If the number of bits of the gradients G is less than the data width W, pieces of data of a plurality of processing units can be stored in the area having the data width W.

In the example of FIG. 3, pieces of data of the gradients G for the data width W received by the reception unit 10-1 and stored in the buffer unit 11-1 are represented by G_{1,1} and G_{1,2} to G_{1,M}, and pieces of data of the gradients G for the data width W received by the reception unit 10-N and stored in the buffer unit 11-N are represented by G_{N,1}, and G_{N,2}, to G_{N,M}.

With a trigger being a predetermined accumulated amount or elapse of a predetermined accumulated time period, each of the extraction units 12-1 to 12-N reads pieces of data of the gradients G for the data width W respectively from the buffer units 11-1 to 11-N, and based on the bit precision information BI reported from the reception units 10-1 to 10-N and a desired processing speed, each of the extraction units 12-1 to 12-N outputs the pieces of data of the gradients G for the data width W to one adder 130 in the addition unit 13 or outputs the pieces of data of the gradients G for the data width W to a plurality of adders 130 in the addition unit 13 in a distributed manner.

The addition unit 13 includes one or more adders 130-1 to 130-M (M is an integer of 2 or greater), and has a function of simultaneously calculating M processing units of the sum of the gradients G. For example, assume that the transmission rate of the communication network 3 is 10 Gbit/s. In this case, to calculate the sum of the gradients G at a processing speed corresponding to the transmission rate, processing of 64 bits or more per clock is required, if clock frequency of the computing interconnect apparatus 1 is 156 MHz.

Provided that the bit precision of the gradients G is 64 bits (double precision, e.g., FP64), necessary processing speed can be achieved if one processing unit of the sum of the gradients G calculated by each of the learning nodes 2-1 to 2-N is calculated per clock. In this case, each of the extraction units 12-1 to 12-N outputs N gradients G for the data width W (here, 64 bits) read from the buffer units 11-1 to 11-N to one adder (for example, 130-1) of the addition unit 13. In this manner, the adder 130-1 calculates the sum ΣG of the N gradients. The sum ΣG of the gradients is expressed as in expression (4), where G₁ to G_{N} represent the gradients G calculated in the learning nodes 2-1 to 2-N.

$$Σ G = {G}_{1} + … + {G}_{N} \qquad ( 4 )$$

Further, provided that the bit precision of the gradients G is 32 bits (single precision, e.g., FP32), necessary processing speed can be achieved if two processing units of the sum of the gradients G calculated by each of the learning nodes 2-1 to 2-N are calculated per clock. In this case, each of the extraction units 12-1 to 12-N divides each of N gradients G for the data width W read from the buffer units 11-1 to 11-N into two, and outputs the divided gradients G to two adders (for example, 130-1 and 130-2) of the addition unit 13 in a distributed manner.

In a case in which the bit precision of the gradients G is 32 bits, the gradients G_{1,1} to G_{N,1} for one processing unit having a data width of 32 bits are stored in the first half of the area having the data width W of each of the buffer units 11-1 to 11-N, and the gradients G_{1,2} to G_{N,2} for one processing unit having a data width of 32 bits, which are different from the gradients G_{1,1} to G_{N,1}, are stored in the second half thereof.

When each of the extraction units 12-1 to 12-N reads the gradients G_{1,1} and G_{1,2} to G_{N,1} and G_{N,2} for the data width W from the buffer units 11-1 to 11-N, each of the extraction units 12-1 to 12-N divides these gradients G separately for each processing unit. Then, each of the extraction units 12-1 to 12-N outputs the gradients G_{1,1} to G_{N,1} of the processing unit of the first half to the adder 130-1, and outputs the gradients G_{1,2} to G_{N,2} of the processing unit of the second half to the adder 130-2. ΣG₁ and ΣG₂ are expressed as in expressions (5) and (6), respectively, which represent the sum of the gradients G calculated in the adders 130-1 and 130-2, respectively.

$$\begin{matrix}Σ {G}_{1} = {G}_{1 , 1} + … + {G}_{N , 1} & ( 5 ) \\ Σ {G}_{2} = {G}_{1 , 2} + … + {G}_{N , 2} & ( 6 )\end{matrix}$$

In a similar manner, provided that the bit precision of the gradients G is 16 bits (half-precision, e.g., FP16), necessary processing speed can be achieved if four processing units of the sum of the gradients G calculated by each of the learning nodes 2-1 to 2-N are calculated per clock. In this case, each of the extraction units 12-1 to 12-N divides each of N gradients G for the data width W read from the buffer units 11-1 to 11-N into four, and outputs the divided gradients G to four adders (for example, 130-1 to 130-4) of the addition unit 13 in a distributed manner.

In a case in which the bit precision of the gradients G is 16 bits, the gradients G_{1,1} to G_{N,1} for one processing unit having a data width of 16 bits are stored in the first quarter of the area having the data width W of each of the buffer units 11-1 to 11-N, and the gradients G_{1,2} to G_{N,2} for one processing unit having a data width of 16 bits, which are different from the gradients G_{1,1} to G_{N,1}, are stored in the second quarter thereof. Further, the gradients G_{1,3} to G_{N,3} for one processing unit having a data width of 16 bits, which are different from the gradients G_{1,1} to G_{N,1} and G_{1,2} to G_{N,2}, are stored in the third quarter of the area having the data width W of each of the buffer units 11-1 to 11-N, and the gradients G_{1,4} to G_{N,4} for one processing unit having a data width of 16 bits, which are different from the gradients G_{1,1} to G_{N,1}, G_{1,2} to G_{N,2}, and G_{1,3} to G_{N,3}, are stored in the fourth quarter thereof.

When each of the extraction units 12-1 to 12-N reads the gradients G_{1,1}, G_{1,2}, G_{1,3}, and G_{1,4} to G_{N,1}, G_{N,2}, G_{N,3}, and G_{N,4} for the data width W from the buffer units 11-1 to 11-N, each of the extraction units 12-1 to 12-N divides these gradients G separately for each processing unit. Then, each of the extraction units 12-1 to 12-N outputs the gradients G_{1,1} to G_{N,1} of the processing unit of the first quarter to the adder 130-1, outputs the gradients G_{1,2} to G_{N,2} of the processing unit of the second quarter to the adder 130-2, outputs the gradients G_{1,3} to G_{N,3} of the processing unit of the third quarter to the adder 130-3, and outputs the gradients G_{1,4} to G_{N,4} of the processing unit of the fourth quarter to the adder 130-4. ΣG₁, ΣG₂, ΣG₃, and ΣG₄ are expressed as in expressions (7), (8), (9), and (10), respectively, which represent the sum of the gradients G calculated in the adders 130-1, 130-2, 130-3, and 130-4, respectively.

$$\begin{matrix}Σ {G}_{1} = {G}_{1 , 1} + … + {G}_{N , 1} & ( 7 ) \\ Σ {G}_{2} = {G}_{1 , 2} + … + {G}_{N , 2} & ( 8 ) \\ Σ {G}_{3} = {G}_{1 , 3} + … + {G}_{N , 3} & ( 9 ) \\ Σ {G}_{4} = {G}_{1 , 4} + … + {G}_{N , 4} & ( 10 )\end{matrix}$$

In this manner, with the provision of one or more adders 130, the present embodiment enables calculation of the sum ΣG of the gradients at a processing speed corresponding to the transmission rate of the communication network 3, regardless of the bit precision of the gradients G.

Note that, in the example described above, the sum of the gradients is calculated at a processing speed corresponding to the transmission rate of the communication network 3, with the distributed deep learning system providing the number of adders 130 of the addition unit 13 in accordance with corresponding bit precision. However, the number of adders 130 included in the addition unit 13 need not necessarily be a fixed number. For example, through the use of a device, such as an FPGA, that is capable of reconfiguration of a logic circuit by dynamically changing the number of adders 130, any bit precision may be supported with the number of adders 130 being a variable.

The distribution unit 14 outputs the sum ΣG of the gradients calculated by the addition unit 13 to each of the transmission units 15-1 to 15-N. In this case, if the bit precision of the gradients G is less than a desired processing speed, since separate pieces of data of ΣG for each of the plurality of processing units are simultaneously output from the plurality of adders 130, the distribution unit 14 collects the separate pieces of data of ΣG for each of the plurality of processing units into one piece of data having the data width W and outputs the collected piece of data to each of the transmission units 15-1 to 15-N. For example, in a case in which the bit precision of the gradients G is 32 bits, ΣG₁ and ΣG₂ are output to each of the transmission units 15-1 to 15-N as a piece of data having the width W, whereas in a case in which the bit precision of the gradients G is 16 bits, ΣG₁, ΣG₂, ΣG₃, and ΣG₄ are output to each of the transmission units 15-1 to 15-N as a piece of data having the width W.

Note that the distribution unit 14 may have a function of selecting a learning node to which the sum of the gradients is to be reported. For example, when the learning nodes 2-1 to 2-N is divided into two (learning groups A and B) and different learning is performed on each of the learning groups, the distribution unit 14 distributes the sum of the gradients of the learning group A and the sum of the gradients of the learning group B to the learning nodes different from each other.

Each of the transmission units 15-1 to 15-N stores the pieces of data of the sum ΣG of the gradients output from the distribution unit 14 in communication packets and transmits the communication packets to the corresponding one of the learning nodes 2-1 to 2-N. Further, each of the transmission units 15-1 to 15-N has a function of retransmitting the communication packets in the event that there is a communication error or the like with the learning nodes 2-1 to 2-N.

### Operation of First Embodiment

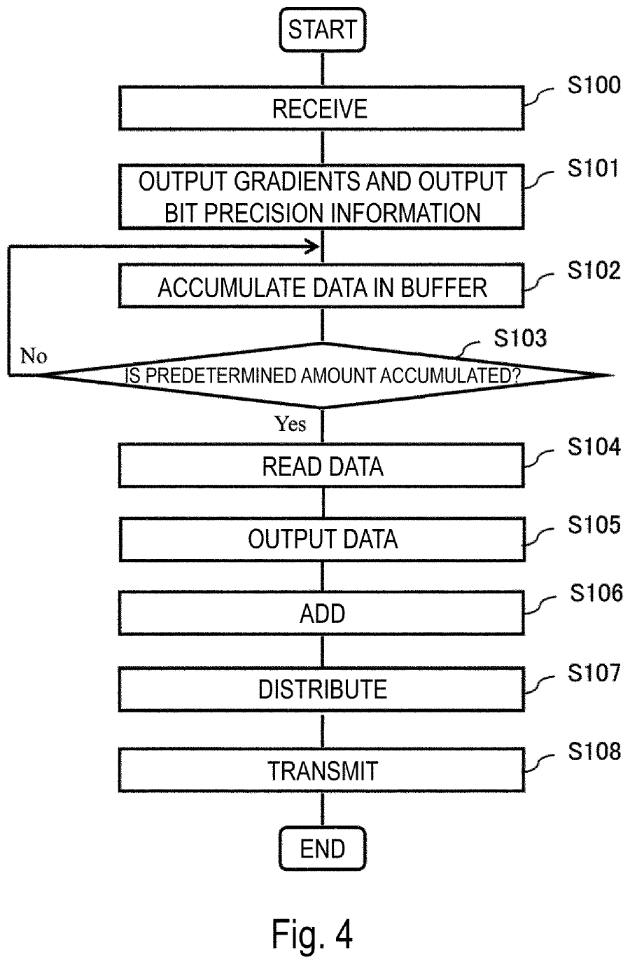

Next, with reference to FIG. 4, operation of the computing interconnect apparatus 1 according to the present embodiment will be described. FIG. 4 is a flowchart illustrating operation of the computing interconnect apparatus 1.

### Reception Units 10-1 to 10-N

First, when the reception units 10-1 to 10-N receive communication packets from the corresponding learning nodes 2-1 to 2-N (Step S100 of FIG. 4), the reception units 10-1 to 10-N extract values of the gradients G from the received communication packets, output the gradients G to the buffer units 11-1 to 11-N, and output the bit precision information BI of the gradients G to the extraction units 12-1 to 12-N (Step S101 of FIG. 4). As described above, by selecting an operation mode of the computing interconnect apparatus 1 corresponding to the bit precision of the gradients G before starting learning, the effect the same as the output of the bit precision information BI can be obtained.

### Buffer Units 11-1 to 11-N

Pieces of data of the gradients G output from the reception units 10-1 to 10-N are accumulated in the buffer units 11-1 to 11-N (Step S102 of FIG. 4). The manner of accumulation of the gradients G is as has been described with reference to FIG. 3.

### Extraction Units 12-1 to 12-N

Next, when a predetermined amount (in the present embodiment, the data width W) of pieces of data of the gradients G is accumulated in all of the buffer units 11-1 to 11-N(Yes in Step S103 of FIG. 4), the extraction units 12-1 to 12-N read the pieces of data of the gradients G for the data width W from each of the buffer units 11-1 to 11-N (Step S104 of FIG. 4). Here, the predetermined amount (data width W) of pieces of data of the gradients G includes as many pieces of data of the gradients G as the number of one or a plurality of processing units to be carried out per clock, which is determined by the bit precision of the gradients G and a desired processing speed. The extraction units 12-1 to 12-N output the pieces of data of the gradients G respectively read from the buffer units 11-1 to 11-N for respective learning nodes to corresponding adders in the adders 130 separate for each of one or the plurality of processing units, separately for each processing unit (Step S105 of FIG. 4).

### Addition Unit 13

Next, the adders 130 separate for each of one or a plurality of processing units in the addition unit 13 add the pieces of data of the gradients G output from the extraction units 12-1 to 12-N separately for each processing unit (Step S106 of FIG. 4).

### Distribution Unit 14

The distribution unit 14 outputs the sum ΣG of the gradients calculated by the addition unit 13 to each of the transmission units 15-1 to 15-N (Step S107 of FIG. 4). In this case, if the bit precision of the gradients G is less than a desired processing speed, since separate pieces of data of ΣG for each of the plurality of processing units are simultaneously output from the plurality of adders 130 of the addition unit 13, the separate pieces of data of ΣG for each of the plurality of processing units are collected into one piece of data having the data width W so as to be output to each of the transmission units 15-1 to 15-N.

### Transmission Units 15-1 to 15-N

Each of the transmission units 15-1 to 15-N stores the pieces of data of the sum ΣG of the gradients output from the distribution unit 14 in communication packets and transmits the communication packets to the corresponding one of the learning nodes 2-1 to 2-N (Step S108 of FIG. 4). As described above, each of the transmission units 15-1 to 15-N retransmits the communication packets in the event that there is a communication error with the learning nodes 2-1 to 2-N.

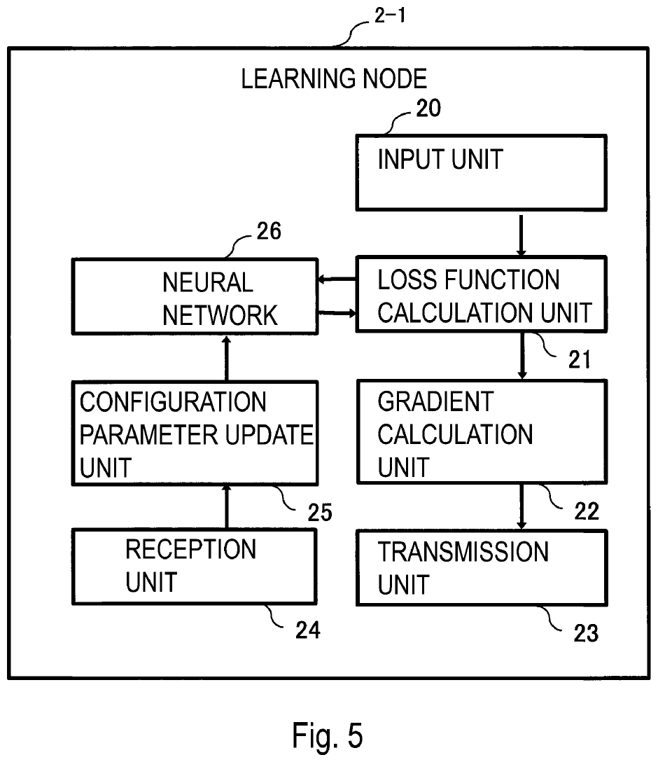

FIG. 5 is a block diagram illustrating a configuration example of the learning node 2-1. The learning node 2-1 includes an input unit 20 that receives learning data, a loss function calculation unit 21, a gradient calculation unit 22, a transmission unit 23 (first transmission unit), a reception unit 24 (first reception unit), a configuration parameter update unit 25, and a neural network 26. The loss function calculation unit 21 calculates the loss function L when the learning data is input. The gradient calculation unit 22 calculates the gradients G of the loss function L. The transmission unit 23 (first transmission unit) packetizes the gradients G calculated by the gradient calculation unit 22 and transmits the gradients G to the computing interconnect apparatus 1. The reception unit 24 (first reception unit) receives the communication packets transmitted from the computing interconnect apparatus 1. The configuration parameter update unit 25 updates configuration parameters (weight parameters) of the neural network by using the sum ΣG of the gradients stored in the communication packets transmitted from the computing interconnect apparatus 1. The neural network 26 has a function of calculating output values of the neural network being a mathematical model.

The example of FIG. 5 illustrates a configuration of the learning node 2-1. However, configurations of other learning nodes are also similar to the configuration of the learning node 2-1. The transmission unit 23 of each of the learning nodes 2-1 to 2-N writes the calculation results of the gradients G calculated by the gradient calculation unit 22 into the data payload of the communication packets and transmits the calculation results to the computing interconnect apparatus 1.

The reception unit 24 of each of the learning nodes 2-1 to 2-N extracts the calculation results of the sum ΣG of the gradients from the data payload of the communication packets received from the computing interconnect apparatus 1.

The configuration parameter update unit 25 of each of the learning nodes 2-1 to 2-N updates the configuration parameters of the neural network 26, based on the calculation results of the sum ΣG of the gradients. Embodiments of the present invention assume a case in which the configuration of the neural network 26 of each of the learning nodes 2-1 to 2-N is the same. This similarly applies to other embodiments to be described below.

Note that the pieces of data as many as the number of processing units to be carried out per clock may be pieces of data for one cycle of the learning processing, or may not be pieces of data for one cycle. In a case in which the bit precision of the gradient G is 32 bits, as described above, the number of processing units to be carried out per clock is 2, for example; however, such pieces of data for two processing units may or may not be pieces of data for one cycle of the learning processing.

### Effect of First Embodiment

As described above, the computing interconnect apparatus 1 according to the present embodiment is connected to the learning nodes 2-1 to 2-N via the communication network 3, and extracts calculation results of the gradients G from communication packets transmitted from the learning nodes 2-1 to 2-N and temporarily accumulates the calculation results in the buffer units 11-1 to 11-N. Then, the computing interconnect apparatus 1 reads, from the buffer units 11-1 to 11-N, as many pieces of data of the gradients G as the number of one or a plurality of processing units to be carried out per clock, which is determined by the bit precision of the gradients G and a desired processing speed, outputs, to the adders 130 separate for each of one or the plurality of processing units, the pieces of data of the gradients G of the processing unit corresponding to the adders 130, calculates the sum ΣG of the gradients separately for each processing unit, and transmits calculation results to each of the learning nodes 2-1 to 2-N.

In the present embodiment, transmission and reception processing of the communication packets between the computing interconnect apparatus 1 and each of the learning nodes 2-1 to 2-N can be subjected to hardware processing at high speed simultaneously in parallel with each other. The distributed deep learning can hence be processed at high speed as compared to a case in which communication processing and addition processing of the gradients G are subjected to software processing in a conventional head node. Further, the conventional distributed deep learning system supports only specific bit precisions. In contrast, by changing the number of adders 130 to be used for calculation in accordance with the bit precision of the gradients G, the present embodiment enables calculation of the sum ΣG of the gradients at a desired processing speed (processing speed corresponding to the transmission rate of the communication network 3), regardless of the bit precision of the gradients G.

### Configuration of Second Embodiment

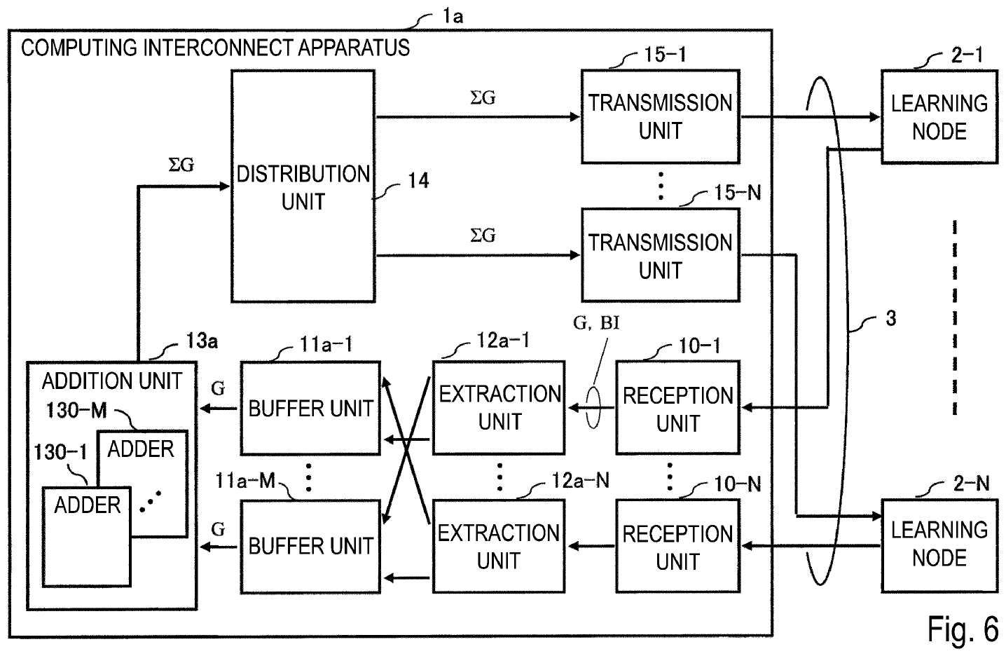

Next, a distributed deep learning system according to a second embodiment of the present invention will be described. FIG. 6 is a block diagram illustrating a configuration of a distributed deep learning system according to the second embodiment. The distributed deep learning system according to the present embodiment includes a computing interconnect apparatus is and learning nodes 2-1 to 2-N.

Similarly to the first embodiment, each of the learning nodes 2-1 to 2-N is an apparatus having a learning function of calculating output values of a neural network being a mathematical model constructed as software, and further updating configuration parameters of the neural network according to learning data so as to enhance precision of the output values. As an implementation method of the learning nodes 2-1 to 2-N, the learning nodes 2-1 to 2-N may be implemented on software of a CPU or a GPU or may be implemented by an LSI circuit that is formed on an FPGA or an ASIC.

The computing interconnect apparatus is includes reception units 10-1 to 10-N, a plurality of buffer units 11a-1 to 11a-M that are configured to store values of gradients, a plurality of extraction units 12a-1 to 12a-N, an addition unit 13a, a distribution unit 14, and transmission units 15-1 to 15-N 15-1 to 15-N. The plurality of extraction units 12a-1 to 12a-N are respectively provided for the learning nodes 2-1 to 2-N, determine the buffer units 11a-1 to 11a-M to be assigned to each of one or a plurality of processing units to be carried out which is determined by the bit precision of the gradients G and a desired processing speed, and output values of the gradients G acquired by the reception units 10-1 to 10-N to corresponding buffer units in the plurality of buffer units 11a-1 to 11a-M separately for each processing unit.

The difference between the present embodiment and the first embodiment lies in the configurations of the extraction units 12a-1 to 12a-N and the buffer units 11a-1 to 11a-M. In the present embodiment, the buffer units 11a-1 to 11a-M store pieces of data of the gradients G so as to correspond to processing of the addition unit 13a.

The reception units 10-1 to 10-N extract values of the gradients G from received communication packets, and output the gradients G and bit precision information BI to the extraction units 12a-1 to 12a-N.

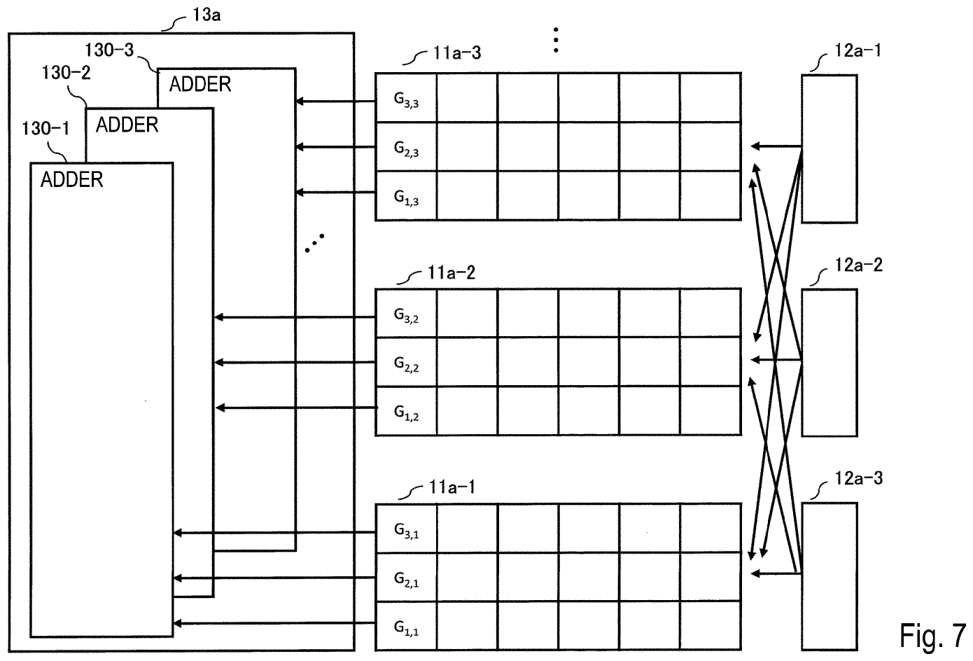

FIG. 7 is a diagram illustrating operations of the extraction units 12a-1 to 12a-N, the buffer units 11a-1 to 11a-M, and the addition unit 13a of the computing interconnect apparatus 1a according to the present embodiment.

Each of the extraction units 12a-1 to 12a-N recognizes the number of processing units to be carried out per clock, based on the bit precision information BI reported from the reception units 10-1 to 10-N and a desired processing speed, determines the buffer units 11a-1 to 11a-M to be assigned to each of the processing units, and outputs pieces of data of the gradients G output from the reception units 10-1 to 10-N to corresponding buffer units in the plurality of buffer units 11a-1 to 11a-M separately for each processing unit.

Each of the buffer units 11a-1 to 11a-M includes a buffer memory having a data width of N×W (64 bits) and a buffer length of L. Each of the buffer units 11a-1 to 11a-N can store pieces of data of the gradients G, with an area of the data width N×W (an area of one column of each of the buffer units 11a-1 to 11a-N of FIG. 7) being used as an area for one word. The difference from the first embodiment lies in that as many buffer units 11a-1 to 11a-M as the number corresponding to the bit precision supported by the distributed deep learning system are provided, instead of being respectively provided for the learning nodes.

Similarly to the first embodiment, the addition unit 13a includes one or more adders 130-1 to 130-M (M is an integer of 2 or greater), and has a function of simultaneously calculating M processing units of the sum of the gradients G. For example, assume that the transmission rate of the communication network 3 is to Gbit/s. In this case, to calculate the sum of the gradients G at a processing speed corresponding to the transmission rate, processing of 64 bits or more per clock is required, if clock frequency of the computing interconnect apparatus 1a is 156 MHz.

In a case in which the bit precision of the gradients G is 64 bits, for example, when pieces of data of the gradients G of N×64 bits are accumulated in one buffer unit (for example, 11a-1), one adder 130-1 of the addition unit 13a reads the pieces of data of the gradients G of N×64 bits from the buffer unit 11a-1, and calculates the sum ΣG of N gradients as shown in expression (4).

In a case in which the bit precision of the gradients G is 32 bits, for example, when pieces of data of the gradients G of N×32 bits are accumulated in each of two buffer units (for example, 11a-1 and 11a-2), two adders 130-1 and 130-2 of the addition unit 13a read the pieces of data of the gradients G of N×32 bits from the buffer units 11a-1 and 11a-2, and calculate the sum ΣG of the gradients.

In a case in which the bit precision of the gradients G is 32 bits, for example, the gradients G_{1,1} to G_{N,1} for one processing unit having a data width of 32 bits are stored in the buffer unit 11a-1, and the gradients G_{1,2} to G_{N,2} for one processing unit having a data width of 32 bits, which are different from the gradients G_{1,1} to G_{N,1}, are stored in the buffer unit 11a-2. The sums ΣG₁ and ΣG₂ of the gradients calculated in the adders 130-1 and 130-2 are expressed as in expression (5) and expression (6).

In a case in which the bit precision of the gradients G is 16 bits, for example, when pieces of data of the gradients G of N×16 bits are accumulated in each of four buffer units (for example, 11a-1 to 11a-4), four adders 130-1 to 130-4 of the addition unit 13a read the pieces of data of the gradients G of N×16 bits from the buffer units 11a-1 to 11a-4, and calculate the sum ΣG of the gradients.

In a case in which the bit precision of the gradients G is 16 bits, for example, the gradients G_{1,1} to G_{N,1} for one processing unit having a data width of 16 bits are stored in the buffer unit 11a-1, and the gradients G_{1,2} to G_{N,2} for one processing unit having a data width of 16 bits, which are different from the gradients G_{1,1} to G_{N,1}, are stored in the buffer unit 11a-2. Further, the gradients G_{1,3} to G_{N,3} for one processing unit having a data width of 16 bits, which are different from the gradients G_{1,1} to G_{N,1} and G_{1,2} to G_{N,2}, are stored in the buffer unit 11a-3, and the gradients G_{1,4} to G_{N,4} for one processing unit having a data width of 16 bits, which are different from the gradients G_{1,1} to G_{N,1}, G_{1,2} to G_{N,2}, and G_{1,3} to G_{N,3}, are stored in the buffer unit 11a-4. The sums ΣG₁, ΣG₂, ΣG₃, and ΣG₄ of the gradients calculated in the adders 130-1, 130-2, 130-3, and 130-4 are expressed as in expression (7) to expression (10).

In this manner, with the provision of one or more adders 130, the present embodiment enables calculation of the sum ΣG of the gradients at a processing speed corresponding to the transmission rate of the communication network 3, regardless of the bit precision of the gradients G.

Note that, in the example described above, the sum of the gradients is calculated at a processing speed corresponding to the transmission rate of the communication network 3, with the distributed deep learning system providing the number of adders 130 of the addition unit 13a in accordance with corresponding bit precision. However, the number of adders 130 included in the addition unit 13a need not necessarily be a fixed number as has been described in the first embodiment.

Similarly to the first embodiment, the distribution unit 14 outputs the sum ΣG of the gradients calculated by the addition unit 13a to each of the transmission units 15-1 to 15-N. As described in the first embodiment, if the bit precision of the gradients G is less than a desired processing speed, since separate pieces of data of ΣG for each of the plurality of processing units are simultaneously output from the plurality of adders 130, the separate pieces of data of ΣG for each of the plurality of processing units are collected into one piece of data having the data width W so as to be output to each of the transmission units 15-1 to 15-N. Further, the distribution unit 14 may have a function of selecting a learning node to which the sum of the gradients is to be reported.

Similarly to the first embodiment, each of the transmission units 15-1 to 15-N stores the pieces of data of the sum ΣG of the gradients output from the distribution unit 14 in communication packets and transmits the communication packets to corresponding learning nodes 2-1 to 2-N. Further, each of the transmission units 15-1 to 15-N has a function of retransmitting the communication packets in the event that there is a communication error or the like with the learning nodes 2-1 to 2-N.

### Operation of Second Embodiment

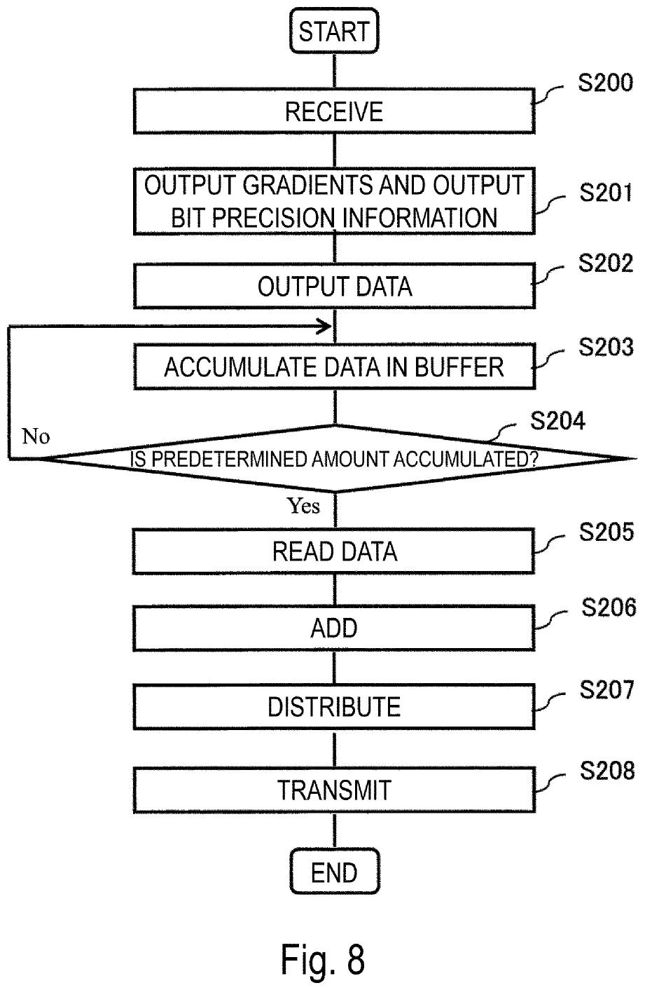

Next, with reference to FIG. 8, operation of the computing interconnect apparatus 1a according to the present embodiment will be described. FIG. 8 is a flowchart illustrating operation of the computing interconnect apparatus 1a.

### Reception Units 10-1 to 10-N

First, when the reception units 10-1 to 10-N receive communication packets from corresponding learning nodes 2-1 to 2-N (Step S200 of FIG. 8), the reception units 10-1 to 10-N extract values of the gradients G from the received communication packets, and output the gradients G and the bit precision information BI of the gradients G to the extraction units 12a-1 to 12a-N (Step S201 of FIG. 8).

### Extraction Units 12a-1 to 12a-N

Each of the extraction units 12a-1 to 12a-N recognizes the number of processing units to be carried out per clock, based on the bit precision information BI reported from the reception units 10-1 to 10-N and a desired processing speed, determines the buffer units 11a-1 to 11a-M to be assigned to each of the processing units, and outputs pieces of data of the gradients G output from the reception units 10-1 to 10-N to corresponding buffer units in the plurality of buffer units 11a-1 to 11a-M separately for each processing unit (Step S202 of FIG. 8).

### Buffer Units 11a-1 to 11a-M

The buffer units 11a-1 to 11a-M accumulate the pieces of data of the gradients G output from the extraction units 12a-1 to 12a-N (Step S203 of FIG. 8).

### Addition Unit 13a

Next, when a predetermined amount (in the present embodiment, N×bit precision) of pieces of data of the gradients G is accumulated in all of the buffer units 11a-1 to 11a-M assigned to each of the processing units by the extraction units 12a-1 to 12a-N(Yes in Step S204 of FIG. 8), the adders 130 separate for each of one or a plurality of processing units in the addition unit 13a read the predetermined amount of pieces of data of the gradients G from corresponding buffer units 11a-1 to 11a-M (Step S205 of FIG. 8). Then, the adders 130 separate for each of the processing units add the pieces of data of the N gradients G read from corresponding buffer units 11a-1 to 11a-M (Step S206 of FIG. 8).

### Distribution Unit 14

The distribution unit 14 outputs the sum ΣG of the gradients calculated by the addition unit 13a to each of the transmission units 15-1 to 15-N (Step S207 of FIG. 8). In this case, if the bit precision of the gradients G is less than a desired processing speed, since separate pieces of data of ΣG for each of the plurality of processing units are simultaneously output from the plurality of adders 130 of the addition unit 13a, the distribution unit 14 collects the separate pieces of data of ΣG for each of the plurality of processing units into one piece of data having the data width W and outputs the collected piece of data to each of the transmission units 15-1 to 15-N.

### Transmission Units 15-1 to 15-N

Each of the transmission units 15-1 to 15-N stores the pieces of data of the sum ΣG of the gradients output from the distribution unit 14 in communication packets and transmits the communication packets to corresponding learning nodes 2-1 to 2-N (Step S208 of FIG. 8).

### Effect of Second Embodiment

As described above, the computing interconnect apparatus is according to the present embodiment is connected to the learning nodes 2-1 to 2-N via the communication network 3, and extracts calculation results of the gradients G from communication packets transmitted from the learning nodes 2-1 to 2-N. The computing interconnect apparatus 1a determines the buffer units 11a-1 to 11a-M to be assigned to each of the processing units to be carried out per clock, which is determined by the bit precision of the gradients G and a desired processing speed, and outputs pieces of data of the gradients G extracted from the communication packets to corresponding buffer units 11a-1 to 11a-M for the processing units of the gradients G. Then, the computing interconnect apparatus is reads the pieces of data of the gradients G separate for each of one or a plurality of processing units from the buffer units 11a-1 to 11a-M, calculates the sum ΣG of the gradients separately for each of the processing units, and transmits calculation results to each of the learning nodes 2-1 to 2-N.

In the present embodiment, transmission and reception processing of the communication packets between the computing interconnect apparatus is and each of the learning nodes 2-1 to 2-N can be subjected to hardware processing at high speed simultaneously in parallel with each other. The distributed deep learning can hence be processed at high speed as compared to a case in which communication processing and addition processing of the gradients G are subjected to software processing in a conventional head node. Further, the conventional distributed deep learning system supports only specific bit precisions. In contrast, by changing the number of buffer units 11a-1 to 11a-M and the number of adders 130 to be used for calculation in accordance with the bit precision of the gradients G, the present embodiment enables calculation of the sum ΣG of the gradients at a desired processing speed (processing speed corresponding to the transmission rate of the communication network 3), regardless of the bit precision of the gradients G.

### Configuration of Third Embodiment

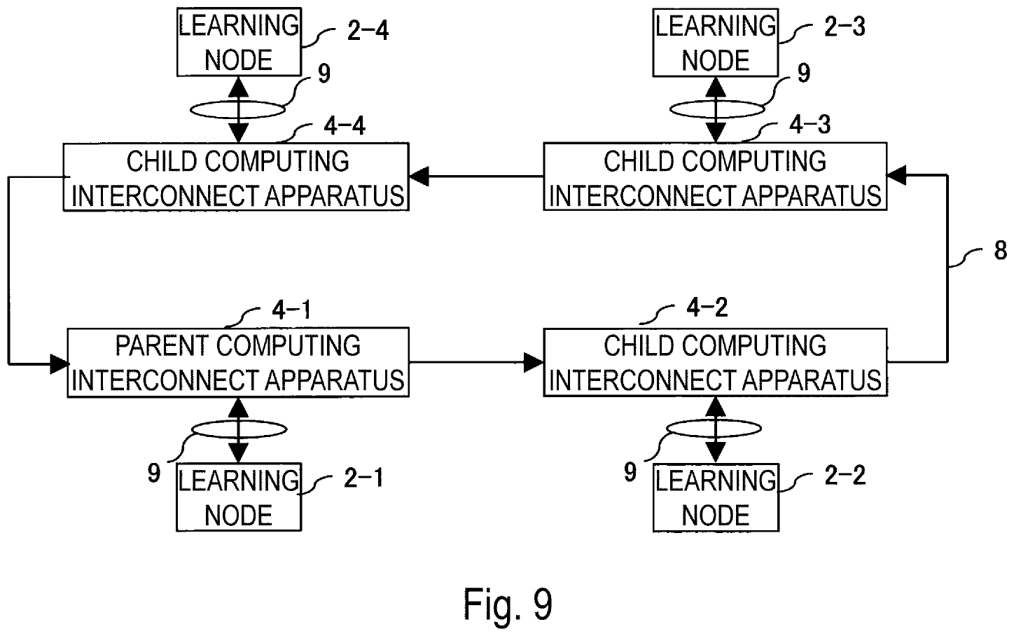

Next, with reference to FIG. 9, a distributed deep learning system according to the third embodiment of the present invention will be described. In the present embodiment, as illustrated in FIG. 9, one parent computing interconnect apparatus 4-1 and a plurality of child computing interconnect apparatuses 4-2 to 4-4 are connected via a ring communication network 8. Further, learning nodes 2-1 to 2-4 are respectively connected to the parent computing interconnect apparatus 4-1 and the child computing interconnect apparatuses 4-2 to 4-4 via communication networks 9.

The difference from the first and second embodiments lies in a configuration where the learning nodes 2-1 to 2-4 are connected by the ring communication network 8.

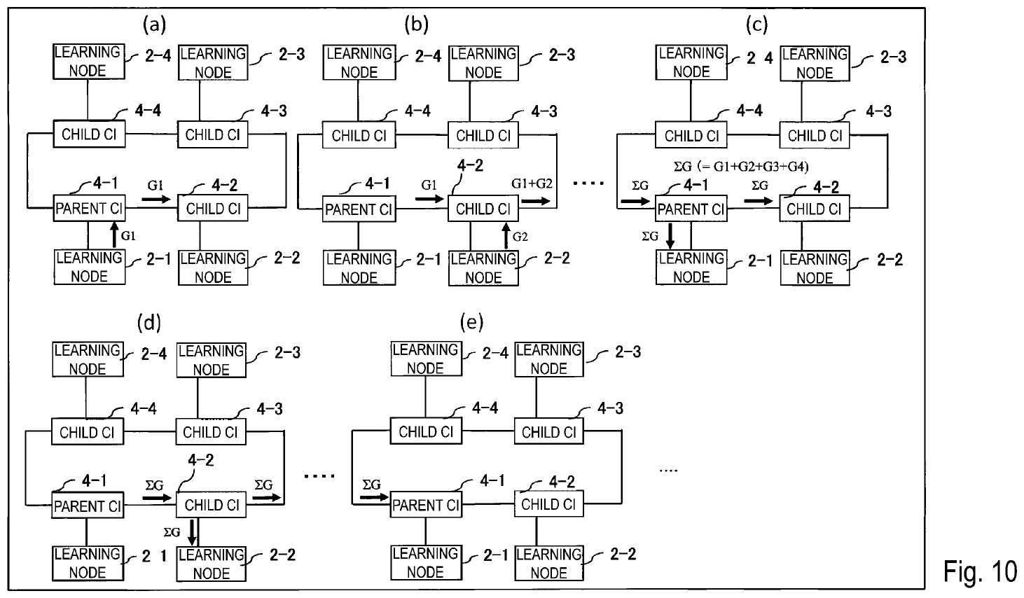

FIG. 10 illustrates operation of the distributed deep learning system according to the present embodiment. First, calculation results G1 of gradients are transmitted from the learning node 2-1 connected to the parent computing interconnect apparatus 4-1 to the parent computing interconnect apparatus 4-1. The parent computing interconnect apparatus 4-1 transfers the calculation results G1 of the gradients to the child computing interconnect apparatus 4-2 (FIG. 10(a)).

The child computing interconnect apparatus 4-2 calculates a sum G1+G2 of the calculation results G1 of the gradients transmitted from the parent computing interconnect apparatus 4-1 and calculation results G2 of gradients transmitted from its directly subordinate learning node 2-2, and transmits the calculation results G1+G2 to the child computing interconnect apparatus 4-3 (FIG. 10(b)).

Similar processing is performed in each of the child computing interconnect apparatuses 4-3 and 4-4. The child computing interconnect apparatus 4-3 calculates a sum G1+G2+G3 of the calculation results G1+G2 being the sum of the gradients transmitted from the child computing interconnect apparatus 4-2 and calculation results G3 of gradients transmitted from its directly subordinate learning node 2-3, and transmits the calculation results G1+G2+G3 to the child computing interconnect apparatus 4-4. The child computing interconnect apparatus 4-4 calculates a sum ΣG=G1+G2+G3+G4 of the calculation results G1+G2+G3 being the sum of the gradients transmitted from the child computing interconnect apparatus 4-3 and calculation results G₄ of gradients transmitted from its directly subordinate learning node 2-4, and transmits the calculation results ΣG to the parent computing interconnect apparatus 4-1.

The parent computing interconnect apparatus 4-1 that has received the calculation results ΣG being the sum of the gradients transmits the received sum ΣG of the gradients to its directly subordinate learning node 2-1 and the child computing interconnect apparatus 4-2 (FIG. 10(c)).

The child computing interconnect apparatus 4-2 that has received the sum ΣG of the gradients transmits the sum ΣG of the gradients to its directly subordinate learning node 2-2 and the child computing interconnect apparatus 4-3 (FIG. 10(d)).

Similar processing is performed in each of the child computing interconnect apparatuses 4-3 and 4-4. The child computing interconnect apparatus 4-3 transmits the sum ΣG of the gradients transmitted from the child computing interconnect apparatus 4-2 to its directly subordinate learning node 2-3 and the child computing interconnect apparatus 4-4. The child computing interconnect apparatus 4-4 transmits the sum ΣG of the gradients transmitted from the child computing interconnect apparatus 4-3 to its directly subordinate learning node 2-4 and the parent computing interconnect apparatus 4-1.

Finally, the parent computing interconnect apparatus 4-1 that has received the sum ΣG of the gradients discards the received sum ΣG of the gradients (FIG. 10(e)). Through the operation described above, the sum ΣG of the gradients is transmitted to each of the learning nodes 2-1 to 2-4.

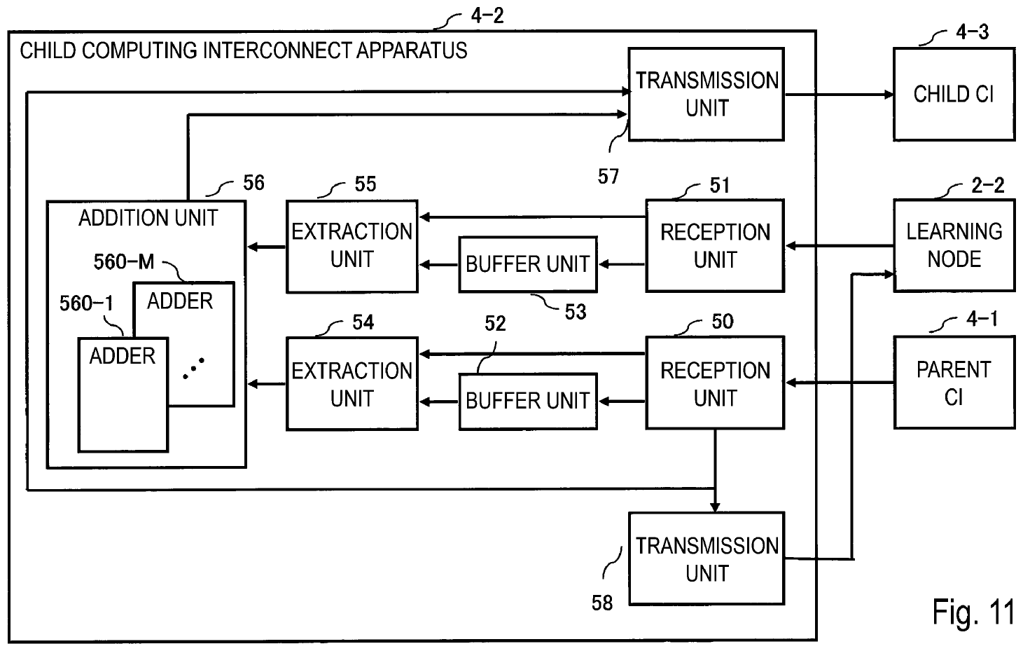

FIG. 11 illustrates a configuration of the child computing interconnect apparatus 4-2 (second computing interconnect apparatus). The child computing interconnect apparatus 4-2 includes a reception unit 50 (fourth reception unit), a reception unit 51 (fifth reception unit), buffer units 52 and 53, extraction units 54 and 55, an addition unit 56, a transmission unit 57 (fourth transmission unit), and a transmission unit 58 (fifth transmission unit). The reception unit 50 (fourth reception unit) receives communication packets from a computing interconnect apparatus adjacent on the upstream side (parent computing interconnect apparatus 4-1 adjacent on the left side) in a ring network configuration that performs communication only in one direction (in the present embodiment, counterclockwise direction). The reception unit 51 (fifth reception unit) receives communication packets from the learning node 2-2 that is connected to the apparatus itself. The buffer units 52 and 53 are respectively provided for the reception units 50 and 51, and store the gradients G acquired by the reception unit 50 and the gradients G acquired by the reception unit 51 for each reception unit. The extraction units 54 and 55 are respectively provided for the reception units 50 and 51, and output pieces of data of the gradients G respectively read from the buffer units 52 and 53 for each reception unit to corresponding adders in one or a plurality of adders 560 separately for each processing unit. The addition unit 56 includes a plurality of adders 560 that calculate the sum of the gradients G output from the extraction units 54 and 55 in parallel separately for each processing unit in accordance with the number of processing units to be carried out, which is determined by the bit precision of the gradients G and a desired processing speed. The transmission unit 57 (fourth transmission unit) writes calculation results of the sum ΣG of the gradients separate for each processing unit obtained by the addition unit 56 or calculation results of the sum ΣG of the gradients acquired by the reception unit 50 into communication packets, and transmits the communication packets to a computing interconnect apparatus adjacent on the downstream side (child computing interconnect apparatus 4-3 adjacent on the right side) of the ring network configuration. The transmission unit 58 (fifth transmission unit) transmits the communication packets to the learning node 2-2 connected to the apparatus.

The example of FIG. 11 illustrates a configuration of the child computing interconnect apparatus 4-2. However, configurations of other child computing interconnect apparatuses are also similar to the configuration of the child computing interconnect apparatus 4-2.

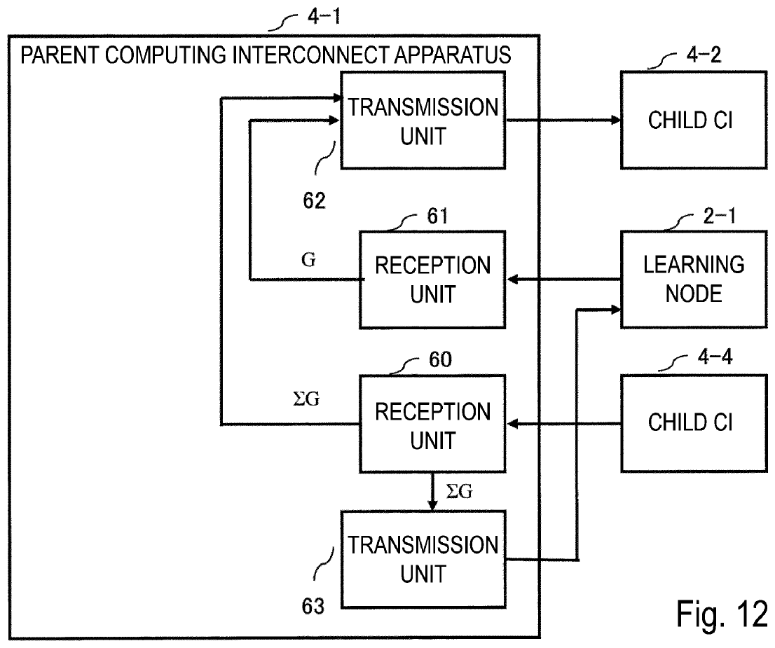

FIG. 12 illustrates a configuration of the parent computing interconnect apparatus 4-1 (first computing interconnect apparatus). The parent computing interconnect apparatus 4-1 includes a reception unit 6o (third reception unit), a reception unit 61 (second reception unit), a transmission unit 62 (second transmission unit), and a transmission unit 63 (third transmission unit). The reception unit 6o (third reception unit) receives communication packets from computing interconnect apparatus adjacent on the upstream side (child computing interconnect apparatus 4-4 adjacent on the left side) in a ring network configuration. The reception unit 61 (second reception unit) receives communication packets from the learning node 2-1 that is connected to the apparatus. The transmission unit 62 (second transmission unit) transmits the communication packets to the computing interconnect apparatus adjacent on the downstream side (child computing interconnect apparatus 4-2 adjacent on the right side) in the ring network configuration. The transmission unit 63 (third transmission unit) transmits the communication packets to the learning node 2-1 that is connected to the apparatus itself.

The reception unit 61 of the parent computing interconnect apparatus 4-1 extracts data of gradient values G1 from the communication packets received from the learning node 2-1, and delivers the data to the transmission unit 62. The transmission unit 62 of the parent computing interconnect apparatus 4-1 stores the gradients G1 received from the reception unit 61 in the data payload of the communication packets, and transmits the gradients G1 to the computing interconnect apparatus 4-2 which is adjacent on the downstream side.

The reception unit 60 of the parent computing interconnect apparatus 4-1 extracts the sum ΣG of the gradients from the communication packets received from the computing interconnect apparatus 4-4 which is adjacent on the upstream side, and delivers the sum ΣG to the transmission units 62 and 63. The transmission unit 62 of the parent computing interconnect apparatus 4-1 stores the sum ΣG of the gradients received from the reception unit 6o in the data payload of the communication packets, and transmits the sum ΣG to the computing interconnect apparatus 4-2 which is adjacent on the downstream side.

The transmission unit 63 of the parent computing interconnect apparatus 4-1 stores the sum ΣG of the gradients received from the reception unit 6o in the data payload of the communication packets, and transmits the sum ΣG to the learning node 2-1.

On the other hand, the reception unit 50 of the child computing interconnect apparatus 4-2 extracts gradient values G1 from the data payload of the communication packets received from the parent computing interconnect apparatus 4-1, and outputs the gradients G1 to the buffer unit 52 also outputs the bit precision information BI of the gradients G1 to the extraction unit 54.

The reception unit 51 of the child computing interconnect apparatus 4-2 extracts gradient values G2 from the data payload of the communication packets received from the learning node 2-2, and outputs the gradients G2 to the buffer unit 53 also outputs the bit precision information BI of the gradients G2 to the extraction unit 55.

The buffer units 52 and 53 have a configuration similar to the configuration of the buffer units 11-1 to 11-N described in the first embodiment. Pieces of data of the gradients G1 and G2 output from the reception units 50 and 51 are accumulated in the buffer units 52 and 53, respectively.

The addition unit 56 has a configuration similar to the configuration of the addition unit 13 described in the first embodiment. When a predetermined amount (in the present embodiment, the data width W) of pieces of data of the gradients G1 and G2 is accumulated in the buffer units 52 and 53, the extraction units 54 and 55 of the child computing interconnect apparatus 4-2 read the pieces of data of the gradients G1 and G2 for the data width W respectively from the buffer units 52 and 53. Similarly to the first embodiment, the predetermined amount (data width W) of pieces of data of the gradients G1 and G2 includes as many pieces of data of the gradients G1 and G2 as the number of one or a plurality of processing units to be carried out per clock, which is determined by the bit precision of the gradients G1 and G2 and a desired processing speed. The extraction units 54 and 55 output, to the adders 560 separate for each of one or the plurality of processing units in the addition unit 56, the pieces of data of the gradients G1 and G2 of the processing units corresponding to the adders 560.

In a case in which the bit precision of the gradients G is 64 bits, the extraction units 54 and 55 output two gradients G1 and G2 for the data width W (here, 64 bits) read from the buffer units 52 and 53 to one adder (for example, 560-1) of the addition unit 56. In this manner, the adder 560-1 calculates the sum ΣG of the two gradients.

In a case in which the bit precision of the gradients G is 32 bits, each of the extraction units 54 and 55 divides each of the two gradients G1 and G2 for the data width W read from the buffer units 52 and 53 into two, and outputs the divided gradients G1 and G2 to two adders (for example, 560-1 and 560-2) of the addition unit 56 in a distributed manner. The gradients G1₁ and G2₁ for one processing unit having a data width of 32 bits are stored in the first half of the area having the data width W of each of the buffer units 52 and 53, and the gradients Gil and G2₂ for one processing unit having a data width of 32 bits, which are different from the gradients G1₁ and G2₁, are stored in the second half thereof.

When each of the extraction units 54 and 55 reads the gradients G1₁, G1₂, G2₁, and G2₂ for the data width W from the buffer units 52 and 53, each of the extraction units 54 and 55 divides these gradients G separately for each processing unit. Then, each of the extraction units 54 and 55 outputs the gradients G1₁ and G2₁ of the processing unit of the first half to the adder 560-1, and outputs the gradients G1₂ and G2₂ of the processing unit of the second half to the adder 560-2. The adder 560-1 calculates the sum ΣG₁ of the two gradients G1₁ and G2₁, and the adder 560-2 calculates the sum ΣG₂ of the two gradients G1₂ and G2₂.

In a case in which the bit precision of the gradients G is 16 bits, each of the extraction units 54 and 55 divides each of two gradients G1 and G2 for the data width W read from the buffer units 52 and 53 into four, and outputs the divided gradients G1 and G2 to four adders (for example, 560-1 to 560-4) of the addition unit 56 in a distributed manner. The gradients G1₁ and G2₁ for one processing unit having a data width of 16 bits are stored in the first quarter of the area having the data width W of each of the buffer units 52 and 53, and the gradients G1₂ and G2₂ for one processing unit having a data width of 16 bits, which are different from the gradients G1₁ and G2₁, are stored in the second quarter thereof. Further, the gradients G1₃ and G2₃ for one processing unit having a data width of 16 bits, which are different from the gradients G1₁, G2₁, G1₂, and G2₂, are stored in the third quarter of the area having the data width W of each of the buffer units 52 and 53, and the gradients G1₄ and G2₄ for one processing unit having a data width of 16 bits, which are different from the gradients G1₁, G2₁, G1₂, G2₂, G1₃, and G2₃, are stored in the fourth quarter thereof.

When each of the extraction units 54 and 55 reads the gradients G1₁, G1₂, G1₃, G1₄, G2₁, G2₂, G2₃, and G2₄ for the data width W from the buffer units 52 and 53, each of the extraction units 54 and 55 divides these gradients G separately for each processing unit. Then, each of the extraction units 54 and 55 outputs the gradients G1₁ and G2₁ for one processing unit of the first quarter to the adder 560-1, outputs the gradients G1₂ and G2₂ for one processing unit of the second quarter to the adder 560-2, outputs the gradients G1₃ and G2₃ for one processing unit of the third quarter to the adder 560-3, and outputs the gradients G1₄ and G2₄ for one processing unit of the fourth quarter to the adder 560-4. The adder 560-1 calculates the sum ΣG₁ of the two gradients G1₁ and G2₁, and the adder 560-2 calculates the sum ΣG₂ of the two gradients G1₂ and G2₂. Further, the adder 560-3 calculates the sum ΣG₃ of the two gradients G1₃ and G2₃, and the adder 560-4 calculates the sum ΣG₄ of the two gradients G1₄ and G2₄.

In this manner, with the provision of one or more adders 560, the present embodiment enables calculation of the sum ΣG of the gradients at a processing speed corresponding to the transmission rate of the communication network 3, regardless of the bit precision of the gradients G.

The transmission unit 57 of the child computing interconnect apparatus 4-2 stores the sum ΣG of the gradients calculated by the addition unit 56 in the data payload of communication packets, and transmits the sum ΣG to the computing interconnect apparatus 403 which is adjacent on the downstream side. In this case, if the bit precision of the gradients G is less than a desired processing speed, since separate pieces of data of ΣG for each of the plurality of processing units are simultaneously output from the plurality of adders 560, the transmission unit 57 collects the separate pieces of data of ΣG for each of the plurality of processing units into one piece of data having the data width W and transmits the collected piece of data. For example, in a case in which the bit precision of the gradients G is 32 bits, the sum ΣG, of the gradients G1₁ and G2₁ and the sum ΣG₂ of the gradients G1₂ and G2₂ are output from the addition unit 56 to the transmission unit 57.

Further, the reception unit 50 of the child computing interconnect apparatus 4-2 extracts the sum ΣG of the gradients from the data payload of the communication packets received from the parent computing interconnect apparatus 4-1, and outputs the sum ΣG of the gradients to the transmission units 57 and 58.

The transmission unit 57 of the child computing interconnect apparatus 4-2 stores the sum ΣG of the gradients received from the reception unit 50 in the data payload of the communication packets, and transmits the sum ΣG to the computing interconnect apparatus 4-3 which is adjacent on the downstream side.

The transmission unit 58 of the child computing interconnect apparatus 4-2 stores the sum ΣG of the gradients received from the reception unit 50 in the data payload of the communication packets, and transmits the sum ΣG to the learning node 2-2.

In a case of the child computing interconnect apparatus 4-3, the reception unit 50 acquires calculation results of the sum ΣG of the gradients G of the child computing interconnect apparatus 4-2, and the buffer unit 52 stores the calculation results of the sum ΣG of the gradients G acquired by the reception unit 50. In a case of the child computing interconnect apparatus 4-4, the reception unit 50 acquires calculation results of the sum of the gradients G of the child computing interconnect apparatus 4-3, and the buffer unit 52 stores the calculation results of the sum of the gradients G acquired by the reception unit 50.

In a case of the child computing interconnect apparatuses 4-3 and 4-4, the extraction units 54 and 55 output the calculation results of the sum ΣG of the gradients read from the buffer unit 52 and the gradients G read from the buffer unit 53 to corresponding adders in one or the plurality of adders 560 separately for each processing unit. In a case of the child computing interconnect apparatuses 4-3 and 4-4, the addition unit 56 calculates the calculation results of the sum ΣG of the gradients and the sum of the gradients G output from the extraction units 54 and 55 in parallel separately for each processing unit.

In a case in which the bit precision of the gradients G is 64 bits, addition processing of the gradients G is sequentially performed up to the child computing interconnect apparatus 4-4, with the result that the sum ΣG of the gradients is expressed as shown in expression (4). In a case in which the bit precision of the gradients G is 32 bits, addition processing of the gradients G is sequentially performed up to the child computing interconnect apparatus 4-4, with the result that the sums ΣG₁ and ΣG₂ of the gradients G are expressed as shown in expression (5) and expression (6). In a case in which the bit precision of the gradient G is 16 bits, addition processing of the gradients G is sequentially performed up to the child computing interconnect apparatus 4-4, with the result that the sums ΣG₁, ΣG₂, ΣG₃, and ΣG₄ of the gradients G are expressed as shown in expression (7) to expression (10).

Note that the example described above illustrates an example of the network configuration in which the computing interconnect apparatuses 4-1 to 4-4 are connected in a ring shape, but the network configuration is not limited to this. For example, the present embodiment may be applied to a network configuration having a two-dimensional torus structure, a three-dimensional torus structure, or the like. Further, the present embodiment may be applied to a network configuration referred to as a “fat tree” in which a network on the upstream side in a network configuration having a tree shape is multiplexed as illustrated in the first embodiment.

### Effect of Third Embodiment

In the present embodiment, transmission and reception processing of the communication packets between the computing interconnect apparatuses 4-1 to 4-4 and each of the learning nodes 2-1 to 2-N can be subjected to hardware processing at high speed simultaneously in parallel with each other. The distributed deep learning can hence be processed at high speed as compared to a case in which communication processing and addition processing of the gradients G are subjected to software processing in a conventional head node.

Further, the conventional distributed deep learning system supports only specific bit precisions. In contrast, by changing the number of adders 560 to be used for calculation in accordance with the bit precision of the gradients G, the present embodiment enables calculation of the sum ΣG of the gradients at a desired processing speed (processing speed corresponding to the transmission rate of the communication network 8), regardless of the bit precision of the gradients G.

### Extension of Embodiments

The present invention has been described above with reference to the embodiments, but the present invention is not limited to the above-described embodiments. Various changes understood by a person skilled in the art within the scope of embodiments of the present invention can be made to the configurations and details of the present invention. Furthermore, the embodiments can be freely combined with each other as long as there is no inconsistency.

The computing interconnect apparatuses 1, 1a, and 4-1 to 4-4 described in the first to third embodiments can be implemented in an LSI circuit formed in an FPGA or an ASIC, for example.

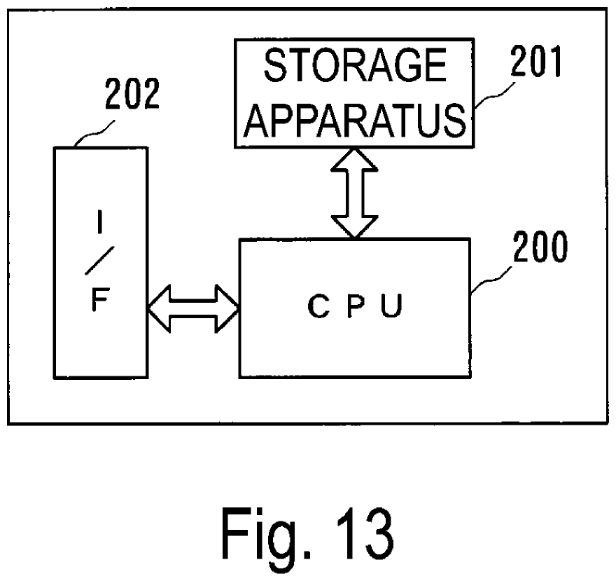

Further, each of the learning nodes 2-1 to 2-N described in the first to third embodiments can be implemented by a computer including a CPU, a storage apparatus, and an interface, and programs for controlling these hardware resources. A configuration example of this computer is illustrated in FIG. 13. The computer includes a CPU 200, a storage apparatus 201, and an interface apparatus (I/F) 202. The communication networks 3 and 9 are connected to the I/F 202. The CPU 200 of each of the learning nodes 2-1 to 2-N executes the processing described in the first to third embodiments in accordance with the programs stored in the storage apparatus 201. As described above, each of the learning nodes 2-1 to 2-N may be implemented in an LSI circuit formed in an FPGA or an ASIC.

### INDUSTRIAL APPLICABILITY

Embodiments of the present invention can be applied to a technology of performing machine learning of a neural network.

### REFERENCE SIGNS LIST

1, 1a . . . Computing interconnect apparatus
2-1 to 2-N . . . Learning node
3, 8, 9 . . . Communication network
4-1 . . . Parent computing interconnect apparatus
4-2 to 4-4 . . . Child computing interconnect apparatus
10-1 to 10-N, 24, 50, 51, 60, 61 . . . Reception unit
11-1 to 11-N, 11a-1 to 11a-M, 52, 53 . . . Buffer unit
12-1 to 12-N, 12a-1 to 12a-N, 54, 55 . . . Extraction unit
13, 56 . . . Addition unit
14 . . . Distribution unit
15-1 to 15-N, 23, 57, 58, 62, 63 . . . Transmission unit
20 . . . Input unit
21 . . . Loss function calculation unit
22 . . . Gradient calculation unit
25 . . . Configuration parameter update unit
26 . . . Neural network
130, 560 . . . Adder

1.-5. (canceled)

6. A distributed deep learning system comprising:
a plurality of learning nodes; and
a computing interconnect apparatus connected to the plurality of learning nodes via a communication network,
wherein each of the plurality of learning nodes comprises:
a gradient calculator configured to calculate a gradient of a loss function, based on output results obtained by inputting learning data to a neural network of a learning target;
a first transmitter configured to write calculation results of the gradient calculator into a first packet and transmit the calculation results to the computing interconnect apparatus;
a first receiver configured to receive a second packet transmitted from the computing interconnect apparatus and acquire a value stored in the second packet; and
a configuration parameter updater configured to update a configuration parameter of the neural network, based on the value acquired by the first receiver, and
wherein the computing interconnect apparatus comprises:
a second receiver configured to receive the first packet transmitted from each of the plurality of learning nodes and acquire a value of the gradient stored in the first packet;
an adder configured to calculate a sum of the gradient acquired by the second receiver in parallel separately for each of processors in accordance with the number of the processors to be carried out being determined by bit precision of the gradient and a desired processing speed; and
a second transmitter configured to write calculation results of the sum of the gradient separate for each of the processors being obtained by the adder into the second packet and transmit the second packet to each of the plurality of learning nodes.

7. The distributed deep learning system according to claim 6, wherein:
the computing interconnect apparatus further comprises
a buffer configured to store the value of the gradient acquired by the second receiver for each of the plurality of learning nodes; and
an extractor configured to output the value of the gradient read from the buffer of each of the plurality of learning nodes to a corresponding adder in one or a plurality of the adders separately for each of the processors, and
the number of the adders configured to calculate the sum of the gradient is changed in accordance with the number of the processors to be carried out being determined by the bit precision of the gradient and the desired processing speed.

8. The distributed deep learning system according to claim 6, wherein:
the computing interconnect apparatus further comprises:
a plurality of buffers each configured to store the value of the gradient; and
an extractor configured to determine one of the plurality of buffers to be assigned to each of one or a plurality of the processors being determined by the bit precision of the gradient and the desired processing speed, and output the value of the gradient acquired by the second receiver to a corresponding buffer in the plurality of buffers separately for each of the processors,
the adder separate for each of the processors calculates the sum of the gradient read from the corresponding buffer, and
the number of the plurality of buffers configured to store the value of the gradient and the number of the adders configured to calculate the sum of the gradient is changed in accordance with the number of the processors to be carried out being determined by the bit precision of the gradient and the desired processing speed.

9. The distributed deep learning system according to claim 6, wherein the computing interconnect apparatus and the learning nodes each comprise a large scale integration (LSI) circuit.

10. A distributed deep learning system comprising:
a plurality of learning nodes; and
a plurality of computing interconnect apparatuses connected to the plurality of respective learning nodes via a communication network,
wherein the plurality of computing interconnect apparatuses are connected by a ring communication network configured to perform communication only in one direction,
wherein each of the plurality of learning nodes comprises:
a gradient calculator configured to calculate a gradient of a loss function, based on output results obtained by inputting learning data to a neural network of a learning target;
a first transmitter configured to write calculation results of the gradient calculator into a packet and transmit the calculation results to one of the plurality of computing interconnect apparatuses connected to the learning node;
a first receiver configured to receive a packet transmitted from the computing interconnect apparatus connected to the learning node and acquire a value stored in the packet; and
a configuration parameter updater configured to update a configuration parameter of the neural network, based on the value acquired by the first receiver,
wherein a first computing interconnect apparatus out of the plurality of computing interconnect apparatuses comprises:
a second receiver configured to receive a packet transmitted from one of the plurality of learning nodes connected to the first computing interconnect apparatus and acquire a value of the gradient stored in the packet;
a third receiver configured to receive a packet transmitted from one of the plurality of computing interconnect apparatuses being adjacent on an upstream side and acquire the calculation results of a sum of the gradient stored in the packet;
a second transmitter configured to write the value of the gradient acquired by the second receiver or the calculation results of the sum of the gradient acquired by the third receiver into a packet and transmit the value or the calculation results to one of the plurality of computing interconnect apparatuses being adjacent on a downstream side; and
a third transmitter configured to write the calculation results of the sum of the gradient acquired by the third receiver into a packet and transmit the calculation results to the learning node connected to the first computing interconnect apparatus, and
wherein a second computing interconnect apparatus other than the first computing interconnect apparatus out of the plurality of computing interconnect apparatuses comprises:
a fourth receiver configured to receive a packet transmitted from one of the plurality of computing interconnect apparatuses being adjacent on the upstream side and acquire the value stored in the packet;
a fifth receiver configured to receive a packet transmitted from one of the plurality of learning nodes connected to the second computing interconnect apparatus and acquire the value of the gradient stored in the packet;
an adder configured to calculate the sum of the gradient or the calculation results of the sum of the gradient acquired by the fourth receiver and the gradient acquired by the fifth receiver in parallel separately for each of processors in accordance with the number of the processors to be carried out being determined by bit precision of the gradient and a desired processing speed;
a fourth transmitter configured to write the calculation results of the sum of the gradient separate for each of the processors being obtained by the adder or the calculation results of the sum of the gradient acquired by the fourth receiver into a packet and transmit the calculation results to one of the plurality of computing interconnect apparatuses being adjacent on the downstream side; and
a fifth transmitter configured to write the calculation results of the sum of the gradient acquired by the fourth receiver into a packet and transmit the calculation results to one of the plurality of learning nodes connected to the second computing interconnect apparatus.

11. The distributed deep learning system according to claim 10, wherein:
the second computing interconnect apparatus further comprises:
a buffer configured to store the gradient or the calculation results of the sum of the gradient acquired by the fourth receiver and the gradient acquired by the fifth receiver for each of receivers; and
an extractor configured to output the gradient or the calculation results of the sum of the gradient read from the buffer corresponding to the fourth receiver and the gradient read from the buffer corresponding to the fifth receiver to a corresponding adder in one or a plurality of the adders separately for each of the processors, and
the number of the adders configured to calculate the sum of the gradient is changed in accordance with the number of the processors to be carried out being determined by the bit precision of the gradient and the desired processing speed.

12. The distributed deep learning system according to claim 10, wherein the learning nodes and the computing interconnect apparatuses each comprise a large scale integration (LSI) circuit.
